(19) United States
(12) Patent Application Publication
(10) Pub. No.: US 2010/0293091 A1
(43) Pub. Date: Nov. 18, 2010

(54) METHOD AND SYSTEM FOR IMPLEMENTING A FAST AMORTIZATION SCHEDULE (FAS) INDEX MORTGAGE FUND

(76) Inventor: Joseph E. Kurczodyna, Lake Forest, IL (US)

Correspondence Address: MARSH, FISCHMANN & BREYFOGLE LLP, 8055 East Tufts Avenue, Suite 450, Denver, CO, 80237, US

(21) Appl. No.: 12/781,020

(22) Filed: May 17, 2010

Related U.S. Application Data
(60) Provisional application No. 61/179,150, filed on May 18, 2009.

(51) Int. Cl. G06Q 40/00

(52) U.S. Cl. 705/38

(57) ABSTRACT

A method for providing mortgage services. The method includes storing in memory a pool of index rates and storing a set of credit ratings each associated with one of the index rates. In the method, with a hardware processor, loan application data that is related to a borrower and a real estate property is received with a hardware processor. The method includes running a credit rating classifier to assign one of the credit ratings based on the received loan application data. A rate association module assigns the one of the index rates associated with the assigned one of the credit ratings to the borrower or a loan application associated with the received loan application data. The pool of index rates includes a number of values (less than five, for example) and each of the values may be associated with an interest rate less than about five percent.

### CROSS-REFERENCE TO RELATED APPLICATIONS

This application claims the benefit of U.S. Provisional Application No. 61/179,150 filed May 18, 2009, which is incorporated herein by reference in its entirety.

### BACKGROUND

1. Field of the Description

The present description relates, in general, to computer-based methods and systems for using the equity markets to facilitate mortgage capital, and, more particularly, to methods and systems for delivering mortgages to the homebuyers and other consumers of mortgage products.

2. Relevant Background

It has long been a shared dream and goal to own your own home to provide a place to live and also to provide a savings vehicle for long term savings. The recent housing crisis has made the housing market much more attractive to buyers due to the decrease in prices in housing values. Unfortunately, though, the typical consumer has found it more difficult to qualify for and obtain a loan or mortgage to purchase a house. Money has recently been tightly restricted in part because of major problems within the securitization equity markets.

Hence, there remains a need for systems and methods for delivering affordable mortgages. Preferably, such systems and methods would be suited for consumers interested in purchasing a home to allow them to build equity while having a place to live. Also, it is preferable that the mortgage methods and systems be developed so as to follow responsible lending practices without placing the home owner in a high risk mortgage that they may not be able to afford in coming years.

### SUMMARY

In brief, the following description describes methods and computer systems for implementing such methods that provide a plan for addressing the question of can you imagine a homebuyer never having to pay more than a 2-5% interest rate on their most valuable asset, their home? The methods and systems described herein facilitate the implementation of a Fast Amortization Schedule (FAS) Index Mortgage Fund that may make this possible. The FAS Index Mortgage Fund originates mortgage loans using an Index Rate of 1-5 points amortized over 10 to 15 years (an index list of numbers). The Index Rate is not tied to current fluctuating mortgage interest rates that are quoted daily. The methods and systems support use of a new residential mortgage fund that may lend money through a new mortgage product to the public. This mortgage product will likely revolutionize and revitalize the housing industry, while providing it with much needed liquidity and allowing stabilization in the market to take place similar to the period from 1940 to 1960.

In some implementations, the FAS Index Mortgage Fund and or its related companies may be a Licensed Residential Mortgage Bank and Loan Originator through one or more states and may expand its geographic presence and licensing as the market warrants. The fund may initially syndicate the product to other licensed mortgage companies that perform all of the functions of a full service house from taking applications, to loan documents and disclosure, to underwriting, pricing, and closing of the loans. Each of these providers of the FAS Index Mortgage Fund may implement the methods and systems described herein to provide unique mortgage services to homebuyers or their customers. The FAS Index Mortgage Fund and related companies will have experienced operators in this industry on its Board of Directors and staff to help guide it through its startup and growth phase.

The basis of the new mortgage product may be a very fast amortizing home mortgage; one which has a borrower paying more principle than interest from the first payment until the last. That allows the homeowner to pay off their mortgage within 10-15 years versus the traditional 30-year frontend, interest-loaded schedule. At the same time, the monthly payments used to pay this mortgage may be comparable to traditional mortgage payments due to the low index rate assigned to the borrower by the methods and systems described herein. In other words, the methods and systems described may make the traditional way of mortgage lending a way of the past, which is desirable with the housing market being in dire need of new innovative solutions to help stave off further deterioration of housing prices. The FAS Index Mortgage Fund which typically uses one or more computer systems to run and/or implement Amortized Index Rate (AIR) software modules/programs will help address these and other goals.

### BRIEF DESCRIPTION OF THE DRAWINGS

FIG. 1 is a functional block diagram of a computer network useful for implementing the FAS index mortgage methods described herein that includes a FAS index mortgage fund computer system or server that may be a special machine or device that is configured to run AIR software to produce FAS index mortgage products; and

FIG. 2 is flow diagram of a FAS index mortgage process according to an embodiment of the invention as may be implemented for example by operation of the system or network of FIG. 1.

### DETAILED DESCRIPTION

Prior to discussing, or as background for, the method and systems of embodiments of the invention, it may be useful first to provide a discussion regarding the history of the residential mortgage market. Regarding the early history of home loans, from the 1940s to the 1980s, when a person wanted to buy a home be it a single family home or condominium, they would go to their local bank and present their paperwork to their loan officer. They would make a formal application and show the bank that they had 20% or more down in cash as a true down payment on their home as well as providing proof of verifiable income as part of the formal application. The bank would make the loan based on the cash down payment and verified income, and the person or couple would pay their mortgage payments religiously over the next 30 years.

During these 30 years, the homebuyer ended up paying for their home 2 to 3 times over. For example, assuming a $200,000 loan with interest rates between 6 and 8% on a 30-year term in just the first 10 years total payments would include $120,000 to $180,000 in interest paid on the loan. Conversely, the homebuyer would have paid $30,000 to 40,000 in principal during the same term. The Bank becomes your or the homebuyer's partner but gets most of its profit up front with 80% of your payment going toward interest during those first 10 years. Home prices over the 30-year term of the mortgage needs to increase 100 to 300% in order for the homebuyer to break even (e.g., to at least not lose money on this American Dream). The early interest the homeowner pays becomes a lucrative profit center for banks.

The fact is inflation-adjusted U.S. home prices increased 0.4% per year from 1890-2004 and 0.7% per year from 1940-2004. If the interest rate on a home mortgage exceeded the average appreciation of 4% over the term of the loan, the original investment and carry cost net out at a loss for the homebuyer. The interest expense the homeowner paid on the mortgage ate away at any appreciation the investment achieved. Loan brokers and mortgage companies came onto the scene in the early 1980's. Their role was to help facilitate loans by offering the competitive loan pricing guidelines offered on a large scale by lenders. Their goal was to lock in their clients with the best interest rate available in the market at the time. In the 1990's, things started to change dramatically when the proliferation of the housing market really started to heat up. The banks focused most of their efforts on ways to cost effectively put money into the market. The banks became warehouse lenders to mortgage companies and shrunk their in-house loan departments.

The mortgage companies started becoming very competitive and aggressive in their pricing, broker incentives, and product offerings. Mortgage companies would literally have 5-10 calls per day from new lenders offering “new loan” products that brokers could offer to their clients. Lenders now underwrote loans with poor credit, no verifiable income, no verifiable assets, interest only, floating rate, and balloon mortgage loans. The brokers would earn their living through origination fees from the client, “discount points,” and “yield spread premiums” from the lender and, third party service provider kickbacks from title companies and others. The market became one of prey and predator. The housing market was heating up; everyone had “equity” in their homes. As long as money was being pushed out the door, no one seemed at all concerned about the borrower being actually able to “afford” the house/investment he was buying.

At this point, it may be useful to discuss how banks get their capital and how they leveraged our/the country's future. In the United States, banks borrow funds at the discount window of the Federal Reserve as they need funds to continue to make aggressive mortgages to homeowners. The funds they borrow allow them to cheaply offer aggressive mortgage products to the public and all the while staying in compliance with net capital ratios required of them by governmental bank examiners. Lenders underwrote these mortgages and would then chop up and sell the loans off to other banks, portfolio buyers, and servicers so that at the end of the day they diversified their exposure and received back the original loan principle from these sales. At that time, the banks would pay off the short term money borrowed from the federal sources at the discount window.

The larger banks also became more creative and securitized those loans in bundles forming Mortgage Backed Securities (MBS), placing them in public offerings as Collateral Mortgage Obligations (CMO's) or Collateral Debt Obligations (CDO's) and then offering the issues through broker dealers in public offerings or new issues. The broker dealers also borrowed funds at the discount window of the Federal Reserve at 30 to 1 ratio. This means that for every $1.00 they put of their own money into a “deal”, these broker dealers would be able to borrow $30.00 from the Feds; previously, this was almost unheard of leverage. The broker dealers underwrote the issues and then offer those products to their clients, such as hedge funds, pension funds, mutual funds, and insurance companies. At the time of the sale, they would pay back the Federal Reserve and pocket substantial fees from the transactions.

The hedge, pension or mutual funds that bought the CMO issues bought them on margin sometimes through the same broker Dealers who issued the securities. Lastly, insurance companies were able to hedge their future piece of the interest income of these debt issues through credit default swaps and, in some cases, speculated with naked credit default swaps and other unregulated exotic derivative contracts. The shear madness of the entire residential mortgage market process was coming to a, head. Numerous questions arose including who owned what mortgage, who serviced it, who was at risk of default, who insured against a loss, and so on, and these often unanswered questions became an enormous monstrosity (e.g., an unstable house that was built on toothpicks). If one was to look at our future interest payments as a glass house, then one stone that could break it all apart would be depreciating home prices.

Now, the discussion turns to the housing crisis beginning with what happened in the most recent real estate bubble in the United States. A real estate bubble or property bubble (or housing bubble for a residential market) is a type of economic bubble that occurs periodically in local or global real estate markets. It is characterized by rapid increases in valuations of real property, such as housing, until it reaches unsustainable levels relative to incomes and other economic elements. Real estate bubbles are invariably followed by severe price decreases (also known as a house price crash). This can result in many owners holding negative equity (i.e., a mortgage debt higher than the current value of the property), which leads to lenders being under collateralized and people not being able to sell their homes because they would not even be able to pay off their mortgage let alone fulfill the dream of making a large profit on this investment.

After Sep. 11, 2001, the Federal Reserve and its chairman feared economic collapse. “History had told us that that type of shock to an economy tends to unwind it, economies are people meeting with each other and it froze everyone in place” was one quote heard at that time. What the country seemed to need was America's consumer to start spending. Retail sales had plummeted by 2.4%, financial institutions faced a difficult time for their business, and the Dow Jones Index fell to 2 year lows. The economy and America's net worth was also still bleeding from the Dot-Com bust. The Federal Reserve, who controls the countries interest rates, made money available to corporations and banks by lowering key interest rates. That action by the Federal Reserve is the lifeline or flight to safety that can stimulate, stabilize, slow down, or speed up economic activity. Keep in mind that if interest rates were already at 0%, the Feds would be out of ammo in the economic war, and interest rates have recently approached this bottom of zero in the United States.

An effect of the lowering of rates was corporations refinancing their long term debt and freeing up cash flow. Banks in turn were also able to make low interest rate loans to smaller companies. All of this activity resulted in increased job activity and a healthier stock market. Additionally, though, lower rates soon made their way into the mortgage market, which created a modern day gold rush in the housing industry. Financial Institutions took advantage of the liquidity the Federal Reserve supplied to the system after the stock market crash of 2000 and thereafter in September 2001. Short-term interest rates fell to their lowest in decades. Long-term mortgage rates dropped slightly. Demand for real estate increased as supply decreased causing a rise in home prices that resulted in the biggest bubble in history for the real estate industry. Soon supply was limited and resulted in even higher prices. This was good news for sellers but made it even tougher for buyers.

One problem was that prices kept rising faster than people's incomes and fewer people were able to buy, which effectively slowed demand and increased the supply of overpriced homes. The median home price rose from $170,000 to $240,000 during this time. Incomes would have needed to double in order to keep up with the price to income ratio, which is the basic affordability measure for housing. With a steep price increase in the market, it was likely that a steep decrease would soon follow. However, before this would happen, in came the new purchaser of non-conforming loans (stated income, stated assets, no income verifications, and so on), which artificially held the market at bay (or puffed up/inflated the ballooning prices) for a while. One might call these people who got into the ballooning market toward the end using nonconforming loans and other exotic mortgage products, the last person in a chain letter or the “bag holder.” Home prices needed to continue on their increasing trend in the first few years for these loans to work out for the homebuyers.

Wall Street and its financial institutions bought these non-conforming loans from newly formed sub-prime mortgage originators. Investment bankers packaged these loans and other mortgage-backed securities in high yielding collateralized debt obligations (CDOs) as discussed above. The CDOs were sold to their clients, including mutual funds, pensions, insurance companies, hedge funds and municipalities in the United States and other countries. The fees earned by Wall Street and other financial institutions, the AAA-rated high-yielding investments, and the American dream were apparently causes to proliferate a blinding hunger for non-conforming loans, and nobody involved in these mortgage products took alarm or looked back until the buyers dried up and the housing market became flooded with overpriced homes.

One of the Federal Reserve's motives behind the lowering of interest rates after Sep. 11, 2001 was to maintain liquidity in the system and to stabilize the economy. Their intention was not to galvanize the housing market, because of the potential boom conditions it would foster. The Federal Reserve did not seem to realize the full extent of the housing bubble in 2005, nor did they realize the enormous growth of the subprime mortgages which represented 20% of all new mortgage loans. They did, however, welcome the extraction of equity from rising home prices given its effect on consumer spending and the economy. If the Federal Reserve in 2005 had the foresight of what would happen and went to Congress or government regulators to suppress the expansion of the subprime market, when it looked like we were dealing with a major increase in home ownership, which is an unquestionable value to society and the economy, would Congress have listened?

During 2001-2005, the housing industry created 800,000 jobs, 40% of all new jobs created in the United States. Alan Greenspan, the chairman of the Federal Reserve, stated, “The presumption that you can incrementally defuse a bubble was a fantasy.” “Clearly you cannot defuse these things unless you hit them right on the head and break the economy, essentially break the potential profitability that is engendering that sort of stuff” The Securities and Exchange Commission (SEC) simply thought that banks and investment firms should police themselves. In recent decades the SEC is largely a breeding ground for regulators waiting to be drafted onto Wall Street and its institutions. The Federal Reserve and Congress could have stopped this crisis from happening. As a result, mortgage originators, banks, Wall Street and Fannie Mae/Freddie Mac, and others grew the apple tree and Main Street bit the apple (e.g., let the problem grow and grow while the country's homebuyers jumped fully in by taking “advantage” of lower interest rates and non-conforming mortgage products in the hopes of making large profits on their real estate purchase).

Now, it may be useful to discuss the more recent (e.g., in 2009 in the United States and elsewhere) economic climate and stimulus actions/plans. As discussed above, the problem/housing market crash occurred with the devaluation of real estate. For more than 50 years, residential assets on the books of banks were always thought to be the least risky of all the assets that banks carried on their balance sheet. For years, the banks carried 25 basis points (or a quarter of 1%) as reserves against these assets for losses; and it was even thought to be too much by many. Presently, a lot of bankers and financial analysts are concerned that the present economy is in a recession that most people agree is as bad, if not worse, than anything ever experienced in the United States and potentially worldwide. The kind of assets that were generally thought to be more risky on the bank's balance sheets, have not begun to react yet, those are the commercial assets. The commercial assets (both commercial real estate and business loans) almost always end up affected by an economic downturn. Businesses cannot afford to rent new office space or expand their production line because demand is down; hence their business cash flow decreasing. The devaluation of these commercial assets is heading in a very troubling direction. One can make the case that in some areas of the country, the residential market is starting to bottom out, but we have not yet seen what the recession is going to do to the rest of the bank's assets.

There is a bottle neck in large institutions in that the capital the bank has is not making its way down to the public, which hurts the economy even further and ultimately makes the low cost of capital the Federal Reserve and other federal sources are offering to banks non-effective. The banks were first on the list to receive stimulus from the federal government. Banks need capital to lend to large and small businesses to create jobs, which creates spending. The banks' capital ratios are so low that the stimulus is not enough to bring them up to the level to lend money to companies and individuals. Due to the proliferation of bad debts the banks are all sitting on, the Bank Regulators are forcing all banks to increase their loss reserves against these assets which ultimately suck up or deplete any capital the banks have or have access to.

One question worth considering is whether we really create jobs by fiscal stimulus by the government that puts money in people's pockets. The real problem is the overwhelming economic need to pay off debt. All free cash flow from corporate, financials, and individuals is going to be used to pay off debt, which is actually a reduction in economic activity. Hence, it appears that there is a need to get interest rates down and create a refinancing ability in the mortgage market. This will reduce debt service on mortgages that builds true equity for homebuyers/homeowners, which in turn puts money in the consumers' pockets that they can then turnaround and spend. It also will be the fuel to form a foundation for the economic recovery so desperately needed in this and other countries now. In turn, this will be the fuel to continue growth in the economy and a hedge against inflation, recession, depression, inflation, and elimination over time of the huge government deficits.

Now, it may be useful to turn the discussion to social responsibility and a potential solution for addressing the above discussed and other problems. Social responsibility is the principle that financial institutions, government agencies, investors and the public have a responsibility, to the welfare of society, to not be solely devoted to maximizing profits. The country needs to get back to socially responsible leading, borrowing, and investing. Companies that are formed in this new era to do good for the people will be a staple in the new economy and receive benefits that may be less visible at the outset but likely will reap more sustainable benefits over the long run. In the methods and systems described herein, the early interest a homebuyer (e.g., any person or company or customer/mortgagee of an institution providing the mortgage services described herein) pays becomes a lucrative profit center for banks (e.g., any lending institution performing the services or using the systems described herein).

United States' President Barak Obama in a recent speech at Georgetown University said “‘There is a parable at the end of the Sermon on the Mount that tells the story of two men. The first built his house on a pile of sand, and it was destroyed as soon as the storm hit. But the second is known as the wise man, for when ‘ . . . the rain descended, and the floods came, and the winds blew, and beat upon that house . . . it fell not: for it was founded upon a rock.’ We cannot rebuild this economy on the same pile of sand. We must build our house upon a rock. We must lay a new foundation for growth and prosperity—a foundation that will move us from an era of borrow and spend to one where we save and invest; where we consume less at home and send more exports abroad. It's a foundation built upon five pillars that will grow our economy and make this new century another American century: new rules for Wall Street that will reward drive and innovation; new investments in education that will make our workforce more skilled and competitive; new investments in renewable energy and technology that will create new jobs and industries; new investments in health care that will cut costs for families and businesses; and new savings in our federal budget that will bring down the debt for future generations. That is the new foundation we must build. That must be our future—and my Administration's policies are designed to achieve that future.”

With these and other goals/needs in mind, the inventor believes we should build our homes and the new economy on a rock. That rock is or may include responsible lending, investing, and borrowing. That rock may include providing fixed and low interest rates (or what the FAS Index Fund calls an “Index Rate”). This Index Rate remains constant at 2 to 5 percent within the FAS Index Fund. A Index Rate provides a fixed and low interest rate for mortgages that is separated from the volatile interest rate set by the Federal Reserve that is passed on to banks and Wall Street and then to the U.S. tax payer or homebuyer on Main Street USA (e.g., via Libor, Fed Funds, Prime and Mortgage Rates, and the like). The FAS Index Fund methods and systems will build our economy on a rock solid foundation with the pillars mentioned above. This turns home ownership back into the American dream versus the great American interest rate skim.

Regarding today's monetary policy, Federal Reserve Chairman Ben Bernanke recently stated:
“I mentioned earlier that the Fed's mandate from the Congress is to foster price stability as well as maximum sustainable employment. The FOMC treats its obligation to ensure price stability extremely seriously. Price stability supports healthy economic growth, for example, by making it easier for households and businesses to plan for the future. In practice, price stability does not require that inflation be literally zero; indeed, although inflation can certainly be too high, it can also be too low. Experience suggests that inflation rates that are close to zero or even negative (corresponding to deflation, or falling prices) can at times be associated with poor economic performance. Cases in point include the United States in the 1930s and the more recent experience of Japan. In their latest quarterly projections of the economy, most members of the FOMC indicated that they would like to see an annual inflation rate of about 2 percent in the longer term. Right now, because of the weakness in economic conditions here and around the world, inflation has been running less than that, and our best forecast is that inflation will remain quite low for some time. Thus, the Fed's proactive policy approach is not at all inconsistent with the goal of price stability in the medium term.
Although inflation seems set to be low for a while, the time will come when the economy has begun to strengthen, financial markets are healing, and the demand for goods and services, which is currently very weak, begins to increase again. At that point, the liquidity that the Fed has put into the system could begin to pose an inflationary threat unless the FOMC acts to remove some of that liquidity and raise the federal funds rate. We have a number of effective tools that will allow us to drain excess liquidity and begin to raise rates at the appropriate time; that said, unwinding or scaling down some of our special lending programs will almost certainly have to be part of our strategy for reducing policy stimulus once the recovery is under way.
We are thinking carefully about these issues; indeed, they have occupied a significant portion of recent FOMC meetings. I can assure you that monetary policy makers are fully committed to acting as needed to withdraw on a timely basis the extraordinary support now being provided to the economy, and we are confident in our ability to do so. To be sure, decisions about when and how quickly to proceed will require a careful balancing of the risk of withdrawing support before the recovery is firmly established versus the risk of allowing inflation to rise above its preferred level in the medium term. However, this delicate balancing of risks is a challenge that central banks face in the early stages of every economic recovery. I believe that we are well equipped to make those judgments appropriately. In addition, when the time comes, our ability to clearly communicate our policy goals and our assessment of the outlook will be crucial to minimizing public uncertainty about our policy decisions.”

The Federal Reserve and the U.S. Treasury Department have put in place two programs, the Trouble Asset Relief Program (TARP), the Term Asset-backed Loan Facility (TALF), and the Public-Private partnerships to support and stimulate the current economic crisis. Most recently, the FOMC has stated that they will be buying one trillion dollars of mortgage backed securities off the market between now and year end (i.e., by the end of 2009). The Feds stated that they will continue to take action to stimulate the economy and open the doors for new entrepreneurial ideas to come to the forefront in an effort to bring stability and to bring the financial crisis to an end. The FAS Index Fund (e.g., methods and systems described herein) is the solution that will once again support Washington (government), Wall Street (financial institutions/banks/lenders), and Main Street (borrowers/homebuyers) working together cohesively.

Now, the description turns to methods and systems according to embodiments of the invention and its likely effect on the real estate and/or financial market. Note, the methods may be implemented using software and hardware components that make up a system, and this may involve one or more software modules/programs that are run on a computer (e.g., a bank's or lender's computers or computer systems to analyze a homebuyer's (which may be more than one person or an entity such as a business that is borrowing money from a bank to purchase real estate) ability to afford a piece of real estate and based on such analysis to select a particular Index Rate), and, in some cases, the running of the software programs causes a general purpose computer to be a special purpose machine configured particularly for performing the methods described herein such as to transform real world information such as income and asset information for a homebuyer and data for a particular real estate (e.g., a parcel of land, a building or house mapped to a particular lot, and the like) into an output that is used to generate a proper mortgage for the homebuyer/bank customer (e.g., a mortgage with a particular Index Rate and length and payment schedule and the like). Embodiments of the invention may also be labeled “the Fund,” “The Product,” and other terms indicating that the methods and systems facilitate creation of services for funding mortgages or mortgage products for homebuyers/borrowers)

In some embodiments, the Fund may originate loans at a very low carrying cost to the borrower. The carrying cost may be calculated using an Index number or Index Rate ranging from 1-5 points (or some other index rate) amortized over 10-15 years (or some other time period). Based on credit history and a few other factors of borrower data collected by a lender (e.g., via an intake or loan application form presented to a bank worker or the customer (e.g., in an online lending environment) via a graphical user interface (GUI) on a computer or its monitor), borrowers may be classified as one of the following credit categories: A, AB, BC, or C credit. Such loan application data may be processed by a loan intake or application processing module while the credit category classifying may be performed by a separate classifier module or the same routine (and on the same or different computer and with the same or different processor(s)).

For example, the credit classifier module may select from a set of credit ratings such as five credit ratings, and these credit ratings may then be used to assign (by the classifier module or a rate association module/routine) an index rate to the borrower/homebuyer. The number of possible credit ratings in the pool or set of assignable credit ratings may vary to practice the invention and may be selected to match the number of differing index rates available for assignment. For example, if four index rates are assignable, then the number of credit ratings may also be four (such as index rates of 2, 3, 4, and 5 percent or the like), but if there are 8 interest rates there may be 8 differing credit ratings (e.g., to allow for fractional rates such as 2.5 or 3.75 or the like).

In one particular embodiment (an exemplary embodiment but not limiting example), four index rates are assignable to a new mortgage or mortgage product generated in response to or based on a loan application and its borrower-provided data (e.g., information related to their ability to repay a loan which may also include information regarding the intended piece of real estate or property), e.g., index rates including 2 percent, 3 percent, 4 percent, and 5 percent (or 4 or more index rates ranging from about 2 to about 5 percent). In such an embodiment, the credit rating classifier module may classify each loan application (or its associated borrower/homebuyer) as one of four credit ratings such as A-credit, AB-credit, BC-credit, and C-credit (or any other useful names/labels for the 4 credit ratings). Each of these credit ratings would be assigned by the credit classifier module by applying a set of credit rating parameters or criterion that defines the requirements for being assigned each credit rating.

In this example, an A-credit rating (which in this case is the best or highest credit rating) would represent or result in the lender being assigned a 2% index rate. An AB-credit rating may be associated with a 3% index rate, a BC-credit rating with a 4% index rate, and a C-credit rating (or the lowest available credit rating) a 5% index rate. Again, such assignment of these index rates may be performed by the Fund computer system and its software such as by the classifier module or a rate association module/routine run by a system processor.

The assigned credit rating may be stored in memory of the computer system and/or output to the borrower (e.g., in an online arrangement or to a bank worker in a bank setting) such as by display in a GUI or form on a monitor or by a hard copy report/print out. In contrast, using current (e.g., as of April 2009) interest rates and utilizing a traditional 30-year mortgage, an A-credit rating would qualify for a 5% interest rate while lower ratings such an AB-credit rating may result in a 6% interest rate, a BC-credit rating a 7% interest rate, and C-credit rating an 8% interest rate. Once the credit rating and index rating assignment have been completed, a mortgage repayment period may be selected for the borrower such as by providing two or more options for repayment periods, having the borrower select one of the periods, and then assigning the repayment period to the particular mortgage product that is being generated by the method/computer system (and its software/hardware). The selection or assignment of a repayment period may include displaying or reporting to the borrower (such as by displaying a repayment table/schedule for two or more repayment periods on a system monitor, on their display of a client node, in a hard copy report, or the like), and then receiving user input selecting one of the repayment periods (such as selecting 10 or 15 years or the like).

The inventor has created Amortized Index Rate software that encompasses all the methods for analyzing loan application and other data to determine credit ratings, assign an index rate based on the credit rating determined for a borrower, provide repayment schedules (including monthly payments showing portions that are principle and interest), and based on received/input user selection of a repayment time period generating a mortgage product for the borrower and a particular property or piece of real estate. The AIR software (or its modules/components) considers and processes the credit and other variables discussed herein in transforming the borrower and property data and the available credit ratings and index rate into a mortgage product according to embodiments of the invention.

The following table shows a comparison between an index rate and the corresponding interest rates currently available in the market today.

TABLE 1
Comparison of a $200,000 loan at 2, 3, 4, 5 Index Rate amortized over
10 and 15 years vs. Traditional 30 year loan at 5, 6, 7, 8% Interest Rate.

| | Period | | | | | | |
|---|---|---|---|---|---|---|---|
| | and | | | | | | |
| | Credit | | Monthly | Principle | Interest | Total | |
| | Rating | Rate | Payments | Paid | Paid | Paid | Appendix |
| Index Rate | 10-A | 2% | $1,840.27 | $200,000 | $20,832 | $220,832 | A |
| Index Rate | 15-A | 2% | $1,287.02 | $200,000 | $31,663 | $231,663 | B |
| Traditional | 30-A | 5% | $1,073.64 | $200,000 | $186,513 | $386,513 | C |
| Index Rate | 10-AB | 3% | $1,931.21 | $200,000 | $31,746 | $231,746 | D |
| Index Rate | 15-AB | 3% | $1,381.16 | $200,000 | $48,610 | $248,610 | E |
| Traditional | 30-AB | 6% | $1,199.10 | $200,000 | $231,677 | $431,677 | F |
| Index Rate | 10-BC | 4% | $2,024.90 | $200,000 | $42,989 | $242,989 | G |
| Index Rate | 15-BC | 4% | $1,479.38 | $200,000 | $66,287 | $266,287 | H |
| Traditional | 30-BC | 7% | $1,330.60 | $200,000 | $279,022 | $479,022 | I |
| Index Rate | 10-C | 5% | $2,121.31 | $200,000 | $54,557 | $254,557 | J |
| Index Rate | 15-C | 5% | $1,581.59 | $200,000 | $84,685 | $284,685 | K |
| Traditional | 30-C | 8% | $1,467.53 | $200,000 | $328,309 | $528,309 | L |

By use of the described methods and systems, the housing market would be affected in a number of positive ways. If interest rates are stabilized between 2-5% as taught herein, the principle payment for a mortgage will be more than interest payments, which will enable the homebuyer/borrower to either qualify for a bigger loan or pay down their home/property in 10 to 15 years. One existing problem lies in the traditional loan amortization schedule. With rates over 5%, interest payments are more than principle payments, and the term of the loan is increased to 30 years in order to qualify the borrower under their income structure.

In contrast, implementation of the Fund via use of the AIR software product or the like will protect many consumers' or borrowers' most valuable asset. The Fund allows credit markets to start over. Amortized Index Rate (AIR) and associated processes decouples homeownership from the volatile interest rate market and installs confidence in the private sector. The Fund may recreate wealth for people and creates jobs in every industry that is connected to homeownership and new construction. Further, homeowners in 10 years will have 60% to 100% equity in their homes without an increase in real estate prices. Use of the AIR software in generating mortgages may stabilize growth, increase gross national product (GNP), and decrease a country's national deficit. It is expected that widespread implementation of the Fund may facilitate real estate market recovery, capital market recovery, and recovery from recession, and it may also allow the Federal Reserve (or a government) to raise interest rates, to raise capital, and to pay for stimulus without super inflation and halting the housing market.

Use of the Fund and its associated processes and systems may also keep the cost of money around the historical appreciation of real estate (e.g., 4%). The public may have the opportunity to own their home sooner and not pay to much more than the historical appreciation rate. It stops a portion of the profiteering of financial institutions from borrowers and gives that spread back to homeowners rather than banks leveraging the spread to create more cash to lend. If inflation comes into play in the future with this housing index in place, the housing industry will keep producing steady growth. The housing industry may not be as vulnerable to the delicate balance when the Federal Reserve or a governmental entity starts withdrawing stimulus to stay off inflation. The government and the financial markets may, as a result, have less fragile situation to deal with, and the Fund may turn the economy from a credit based growth economy to an asset and revenue base growth economy which may increase jobs and the tax base. Stabilizing the housing industry via use of the Fund and associated processes/systems builds a foundation for lasting prosperity. Currently, we need real estate prices to rise in order to prevent another major collapse of the financial institutions. It should be understood that historically housing and auto markets usually lead us out of recession, and the Fund may assist recovery of the housing market.

A low index rate would also help bring back U.S. home affordability. The Amortized Index Rate concept changes the rules in which our financial institutions are built on and presents an opportunity for our country and the world financial markets to restart. The healthy borrower needs confidence to start spending and stimulate the economy, and in many economies healthy borrowers may actually bail out bad assets. Banks prosper by a resurge in real estate prices, while credit and housing led us into a downturn in the economy it may have to lead us out. Keeping a low index rate as described herein may act as hedge against inflation. Encouraging/facilitating each homebuyer/borrower to pay down principle and build equity allows them to own one of their most precious assets in a shorter amount of time. Building equity and owning a home/property faster may shorten turn over to a larger home, which can lead to the supply of homes being bought up by new purchases from good borrowers.

The following provides further description of the mortgage methods and systems of the invention including the software product(s), use of an Amortized Index Rate (AIR) or Index Rate, and general underwriting guidelines that may be used in some embodiments. The FAS Index Mortgage Fund (e.g., a computer system or network may be used to provide the functions/services of the Fund) utilizes an Index Rate. The Index Rate may include a set of numbers (or indices) such as five numbers 1 through 5. A potential borrower is assigned a number based on their credit rating and a few other variables (e.g., by a credit classifying module run a computer system). The index rate assigned is amortized over the term of the loan (repayment period selected by borrower or a default/assigned term of years such as 10 to 15 or the like). The inventor has created Amortized Index Rate (AIR) software encompassing all the credit and other variables that may be accessed from memory as useful for performing the data processing and transformations described herein.

Mortgage loan and credit standards may be created and reviewed through guidelines implemented by the FAS Manager. In some embodiments, borrowers may be in three (3) credit categories A, B or C with, in some cases, subcategories to match the number of index rates assignable in a particular system or implementation of the mortgage generation method. The guidelines shown below are broad in nature and not intended to teach the only way to implement the invention. If a borrower is qualified and fits into the Amortized Index Rate, the use of the proceeds of the load are typically not limited, and the funds may be used for purchase, rehab, investment, refinance, cash out, and the like (but are typically secured by a real estate property).

The “A” (or higher credit rating) borrowers may pay a 2-3% amortized index rate (AIR) on their home loans. Some of the traditional characteristics of borrowers within this category may be (as may be assigned by the credit classifying module based on user-provided loan applications/qualification data input forms): Fully verifiable income and assets; Long term job history; Loan to values 70% or below based on a current appraisal or purchase price; and Middle credit score of a minimum of 700 from the three reporting bureaus. In contrast, “B” credit rating (or middle range credit rating) borrowers may pay a 3-4% amortized index rate (AIR) on their home loans. Some of the traditional characteristics of borrowers within this category may be: Easily verifiable income; Stable industry or job history; Loan to values between 71%-79% based on a current appraisal or purchase price; and Middle credit score of a minimum of 620 from the three reporting bureaus. Finally, in this 3-credit rating category implementation, “C” credit rating (or lowest qualifying credit rating) borrowers may pay a 4-5% amortized index rate (AIR) on their home loans. Some of the traditional characteristics of borrowers within this category may be: Current Paystub verification; Loan to values between 80%-90% based on a current appraisal or purchase price; and Middle credit score of a minimum of 575 from the three reporting bureaus.

In one embodiment, there would be a FAS Manager or The Mortgage “Processor” that is the facilitator of making the loans and getting the FAS Index Fund money into the individual homeowner's hands. This may, for example, be a full service mortgage house that implements a computer system running the software (e.g., AIR software) described herein. The various roles that this company may focus on may be marketing the FAS Index Fund Mortgage product through email, word of mouth, and otherwise and participating in joint ventures with online mortgage companies, mortgage brokers, and various housing authorities and non-profits.

The loan process that may be provided by a system running the AIR software may be as follows. A client calls a Loan Officer of the FAS Manager to apply for a mortgage under the FAS Index Fund Program. In other cases, a client may call an outside licensed residential mortgage broker to apply for a mortgage under the FAS Index Fund Program. The details or data provided via the loan application (again which may be entered via an online fillable form, via data entry by a bank/FAS Manager employee, or the like so as to make this borrower data available to the AIR software and its credit assigning module) may include traditional income, assets, liabilities, and credit information. The Loan Officer at FASIF Manager or the Broker the client is using will inform the client of the backup documentation that the client will need to provide assuming the loan application is approved.

The client may be sent a full set of mortgage disclosure documentation as required by law which will include all estimated fees and costs to close the loan to the owner. The FASIF Manager Loan Officer or Processor will input the client application into a software program called Amortized Index Rate (AIR) software and receive a decision on the application and index rate shortly, such as within 1 hour or some other useful time period. The Amortized Index Rate software uses 2 main variables: the credit rating and an index range (with the credit rating being correlated to an index range or value by the AIR software). Applicants may in some embodiments fall into one of 3 broad credit categories A, B, or C (or not qualify at all). The applicant's final index rate (0, 1, 2, 3, 4, 5, or the like (e.g., a value from 0 to 5 in this example)) may be based upon other variables surrounding the loan.

The FASIF Manager loan officer (or a bank employee or the like) may inform the client or the broker of the underwriting decision and proceed with collecting the backup documentation used to fully process the loan. The file will be moved to a closing department of the FASIF Manager. Assuming the client accepts the terms of the FAS Index Fund Loan (after selecting a term for the loan), the FASIF Manager loan officer or broker may order the residential home appraisal and start coordinating a closing with the buyer. Further, a Title Policy may be ordered and reviewed. Payoffs from the client's current mortgage holders may be ordered and five days (or some other time period) prior to the day of closing, the FASIF Manager loan officer and the closing department may coordinate the requirements of closing including funds the buyer should bring to closing and order loan documentation to be printed out. The loan documents along with all other pertinent information will be sent to the closing title company one day or the like prior to closing. Three days (or some other time period) prior to closing, the FASIF Manager may order the funds from FAS Index Fund and provide the necessary documentation to facilitate the transfer of funds to the closing title company. The Client executes all loan documents and the loan is closed and funded with a lien filing put in place on title through a title company.

Although not necessary for all implementations of the invention, it may be useful to discuss securitization, transparency and accountability. The Fast Amortization Schedule Index Mortgage Fund (FASIMF) may initially be capitalized with $1-10 million and may seek a warehouse line of credit (10 to 1) at the Federal Reserve discount window. The FAS Manager may operate the FASIMF and the FAS Manager may also facilitate the securitization of mortgages underwritten by FASIMF. The FAS Manager may attempt to sell these mortgages to established Issuers of Agency Bonds, (FANNIE MAE/FREDDIE MAC/GINNIE MAE), and the like. GNMA, FNMA and FHLMC buy mortgages from financial institutions that make loans and then they group them in $1 million or more pools, and then they sell unit shares in these pools to investors. The agency then may issue bonds on these pools through financial institutions, marketing them through brokers. The bonds thus raise additional capital for the agency to replenish its resources. The FAS Manager may act in the same capacity and pool the interest and principle payments of the underlying mortgage and offer those mortgage-backed securities in a FASIMA convertible bond or the like.

Fast Amortization Schedule Mortgage Association (FASIMA) may be a wholly-owned corporate agency operating within a public company, in which the bonds are converted into, FAS Manager may acquire an existing public shell to do so. FASIMA's primary goal may be to channel funds back to FASIMF for its primary mortgage market in order to increase the availability of capital for new mortgage loans. It is to be determined if debt issued and guaranteed by FASIMA might be backed by the full faith and credit of the U.S. government and might or might not be fully taxable.

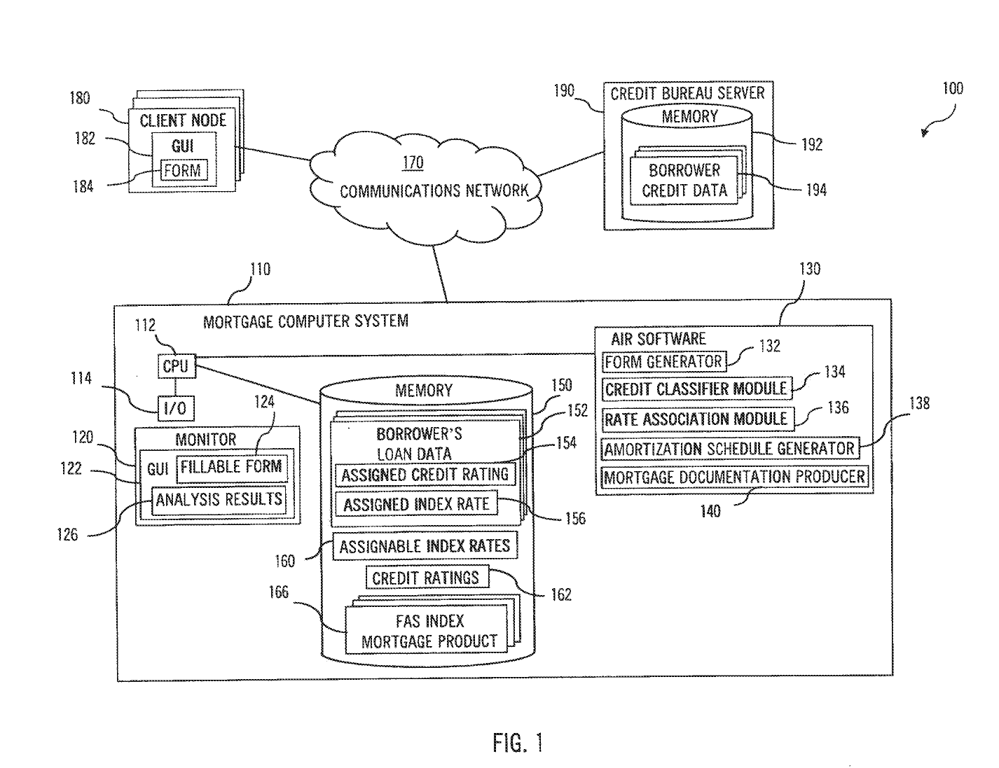

FIG. 1 illustrates a computer network or system 100 that may be used to implement the methods described herein. Specifically, the system 100 includes a computer system or server 110, which may be a special machine such as a personal computer (e.g., a desktop, a laptop, a notebook, or other computing device) or a server adapted for serving data over the communications network 170 (e.g., the Internet, an intranet, a LAN, a WAN, or other digital communications network). The computer system 110 includes a processor 112 the runs the AIR software 130 (e.g., is a special machine adapted to transform data such as loan application data, credit data, index rates, and the like into credit ratings, amortization schedules, and mortgage products). The processor 112 also manages operation of I/O devices 114 such as keyboards, a mouse, a touch screen/pad, and the like to allow a user of the system 110 to enter data such as borrower loan data 152 via a fillable form 124.

The system 110 also includes a monitor 120 that is used to display data to a user (and, in some cases, to a borrower) such as via a graphical user interface 122 that may be used to display the fillable loan application form 124 and other data input screens/interfaces and also to display/output analysis results 126 (e.g., credit ratings, assigned index rates for a borrower, amortization tables, loan payment information, mortgage product data, and the like). The system 110 also includes memory or data storage 150 used here to store information for performing the FAS index mortgage process, and this data may include borrower's loan data 152, which may include information collected as part of the loan application process via fillable form(s) 124 or via forms 184 provided or served by the server 110 over network 170 to a client operating a network node or computing device 180 in their GUI 182 (which may be created in part by form generator 132). The loan application data 152 may also include information such as borrower credit data 194 gathered via the network 170 from third party servers such as credit bureau server 190 storing data 194 in its data stores 192 (or such credit and other application data may be gathered in other manners). The borrower's loan data may include a credit rating 154 assigned by the AIR software 130 and an assigned index rate 156 also assigned by the AIR software 130 (e.g., based on the credit rating 154).

The memory 150 also stores index rates 160 assignable by the AIR software 130 such as rates from 0 to 5 (e.g., numbers associated with interest rates such as 0 percent, 1 percent, 2 percent, 3 percent, 4 percent, and 5 percent or the like) and credit ratings 162 and their associated index rates 160 (e.g., 5 credit ratings that may be assigned from highest/best to lowest/worst and each of these may define or indicate which index rating is associated with them, and in some cases, a “denied rating” may be provided indicating that the applicant/borrower does not meet some minimum set of criteria for obtaining a mortgage). Additionally, the memory 150 may at least temporarily store the produced or generated FAS index mortgage product 166 for successful applicants or borrowers. The product 166 may include information from the borrower's loan data, the assigned index rate, a payment or amortization schedule/data, and so on, with some or all of this data/information being generated or produced (and/or gathered/correlated) by the AIR software 130.

The AIR software 130 may include a form generator 132 that produces the fillable form(s) 124, 184 and/or produces user interfaces that are used to prompt bank or FAS manager employees to gather load application data or enter such data (or to prompt the applicant themselves such as in the online arrangement shown with client node 180). The gathered data may be stored in the memory 150 as part of the loan data or borrower input data 152. The AIR software 130 also includes a credit classifier module 134 that acts to determine based on the borrower's load data 152 (which may include borrower credit data 194) one of a set of credit ratings 162 to assign to the borrower or their loan application (as shown at 154). For example, the borrower or their application may assigned the highest credit rating from the set 162 (e.g., an A credit rating or the like). The AIR software 130 also includes a rate association module 136 that acts to select one (i.e., the assigned index rate 156) of the assignable index rates 160 (e.g., a set of index rates from 2 to 5 having a number equal to the number of credit ratings 162) based on the assigned credit rating 154. In the above example, a borrower assigned the highest credit rating may also be assigned the lowest index rate (such as 0 percent, 1 percent, 2 percent or the like depending on the set of assignable/available index rates 160).

Further, the AIR software 130 includes an amortization schedule generator 138 that functions to process a requested mortgage amount based upon the assigned index rate an amortization schedule for one or more loan terms/repayment periods. The amortization schedule(s) may be reported or displayed to the borrower such as in analysis results 126 or in GUI 182 (or in a hard copy version). The user may select a term for the loan, and a mortgage documentation production module 140 may be used by the CPU 112 to produce a FAS index mortgage product 166 that reflects at least the loan amount, the assigned index rate, the loan term, and a payment schedule for the borrowers along with other load data 152 (such as the borrower's full name, the property definition/defining data, and so on).

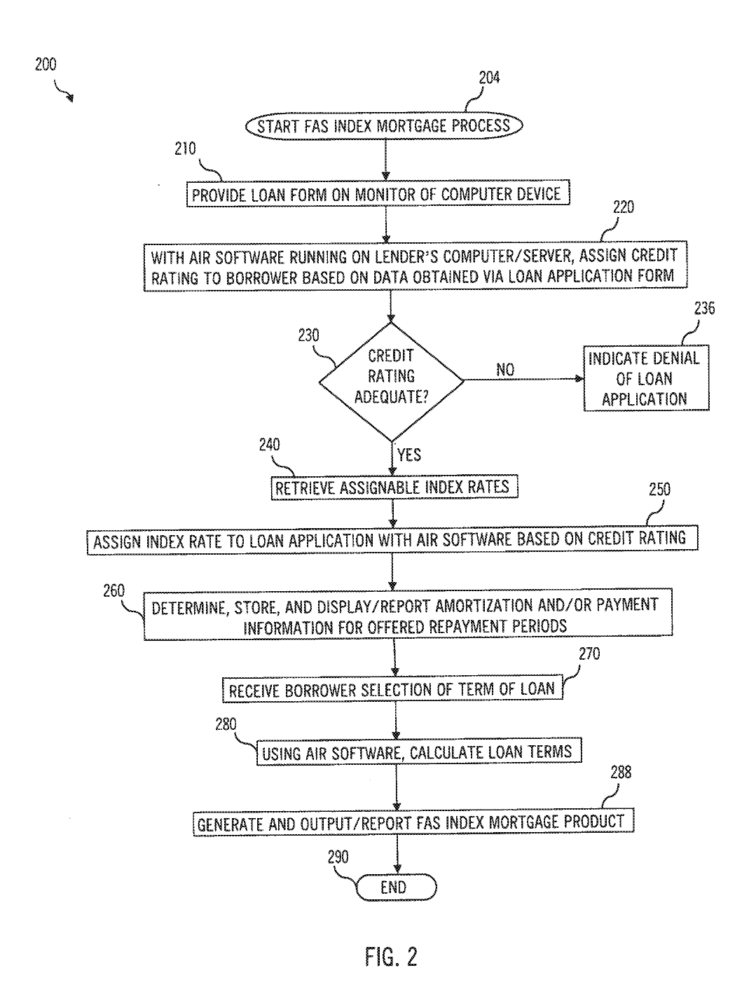

FIG. 2 illustrates a FAS index mortgage process 200 as may be carried out by operation of the system or network 100 of FIG. 1. The method 200 starts at 204 such as with establishing a FAS index mortgage fund and providing AIR software on one or more bank/lender computer devices. At 210, the method 200 continues with using the AIR software to generate and present a load form (or loan information collection tool/interface) on a monitor of a computer device, such as a device used directly by the loan applicant or a bank/lender employee. At 220, the method 200 includes using the AIR software, which is run by a processor on one or more computing devices, to assign a credit rating to the borrower or their loan application based on the data obtained via the loan application form (which may be communicated over the Internet or other digital data communications network). The credit rating typically will indicate whether the borrower has adequate credit/credentials to receive a mortgage, and this is verified at 230. If not, the method 200 continues at 236 with outputting an indication of that the applicant's loan application is denied. If the credit rating is adequate at 230, the method 200 continues at 240 with the AIR software retrieving/accessing assignable index rates and then at 250 assigning one of these index rates to the loan application or borrower based on the previously assigned credit rating (e.g., a middle credit rating may result in a mid-index rate being assigned and so on).

At 260, the method 200 includes determining, storing, and displaying/reporting amortization and/or payment information for one or more proposed loans for one or more repayment periods or loan terms (e.g., payment schedule/information for a 5 year loan, a 10 year loan, a 15 year loan, and the like). This information may be displayed to the borrower (and/or loan officer) on a computer monitor or the like and/or printed out for review/viewing by the borrower. At 270, the method 200 includes receiving the borrower's selection of one of the terms or repayment periods for use in generating the mortgage, and such information may be inputted by the borrower or another operator via a fillable form, user interface, or the like provided on a computer device or one linked to such a computer device. At 280, the AIR software is run or used to calculate one or more loan terms/data, and at 288, the AIR software may generate and output/report the FAS index mortgage product for execution by the borrower. The method 200 ends at 290.

The above described invention including the preferred embodiment and the best mode of the invention known to the inventor at the time of filing is given by illustrative examples only. It will be readily appreciated that many deviations may be made from the specific embodiments disclosed in the specification without departing from the spirit and scope of the invention.

The following are amortization tables that provide more detail for the data in Table 1, which was provided and described above.

TABLE 2
Annual Summary $200,000 at 2% 10 Years

| | Payments | Principle | Interest | | |
|---|---|---|---|---|---|
| Year | Made | Portion | Portion | Interest to Date | Principle Remaining |
| 2010 | $22,083.24 | $18,249.94 | $3,833.30 | $3,833.30 | $181,750.06 |
| 2011 | $22,083.24 | $18,618.29 | $3,464.95 | $7,298.25 | $163,131.77 |
| 2012 | $22,083.24 | $18,994.10 | $3,089.14 | $10,387.39 | $144,137.67 |
| 2013 | $22,083.24 | $19,377.47 | $2,705.77 | $13,093.16 | $124,760.20 |
| 2014 | $22,083.24 | $19,768.61 | $2,314.63 | $15,407.79 | $104,991.59 |
| 2015 | $22,083.24 | $20,167.61 | $1,915.63 | $17,323.42 | $84,823.98 |
| 2016 | $22,083.24 | $20,574.68 | $1,508.56 | $18,831.98 | $64,249.30 |
| 2017 | $22,083.24 | $20,989.97 | $1,093.27 | $19,925.25 | $43,259.33 |
| 2018 | $22,083.24 | $21,413.64 | $669.60 | $20,594.85 | $21,845.69 |
| 2019 | $22,083.24 | $21,845.69 | $237.39 | $20,832.24 | $0.00 |
| Totals | $220,832.40 | $200,000.00 | $20,832.24 | | |

TABLE 3
Annual Summary $200,000 at 2% 15 Years

| | Payments | Principle | Interest | | |
|---|---|---|---|---|---|
| Year | Made | Portion | Portion | Interest to Date | Principle Remaining |
| 2010 | $15,444.24 | $11,549.74 | $3,894.50 | $3,894.50 | $188,450.26 |
| 2011 | $15,444.24 | $11,782.85 | $3,661.39 | $7,555.89 | $176,667.41 |
| 2012 | $15,444.24 | $12,020.68 | $3,423.56 | $10,979.45 | $164,646.73 |
| 2013 | $15,444.24 | $12,263.33 | $3,180.91 | $14,160.36 | $152,383.40 |
| 2014 | $15,444.24 | $12,510.84 | $2,933.40 | $17,093.76 | $139,872.56 |
| 2015 | $15,444.24 | $12,763.36 | $2,680.88 | $19,774.64 | $127,109.20 |
| 2016 | $15,444.24 | $13,021.00 | $2,423.24 | $22,197.88 | $114,088.20 |
| 2017 | $15,444.24 | $13,283.79 | $2,160.45 | $24,358.33 | $100,804.41 |
| 2018 | $15,444.24 | $13,551.93 | $1,892.31 | $26,250.64 | $87,252.48 |
| 2019 | $15,444.24 | $13,825.46 | $1,618.78 | $27,869.42 | $73,427.02 |
| 2020 | $15,444.24 | $14,104.53 | $1,339.71 | $29,209.13 | $59,322.49 |
| 2021 | $15,444.24 | $14,389.20 | $1,055.01 | $30,264.14 | $44,933.29 |
| 2022 | $15,444.24 | $14,679.64 | $764.60 | $31,028.74 | $30,253.65 |
| 2023 | $15,444.24 | $14,975.95 | $468.29 | $31,497.03 | $15,277.70 |
| 2024 | $15,444.24 | $15,277.70 | $165.98 | $31,663.01 | $0.00 |
| Totals | $231,663.60 | $200,000.00 | $31,663.01 | | |

TABLE 4
Annual Summary $200,000 at 5% 30 Years

| | Payments | Principle | Interest | | |
|---|---|---|---|---|---|
| Year | Made | Portion | Portion | Interest to Date | Principle Remaining |
| 2010 | $12,883.68 | $2,950.68 | $9,933.00 | $9,933.00 | $197,049.32 |
| 2011 | $12,883.68 | $3,101.65 | $9,782.03 | $19,715.03 | $193,947.67 |
| 2012 | $12,883.68 | $3,260.34 | $9,623.34 | $29,338.37 | $190,687.33 |
| 2013 | $12,883.68 | $3,427.13 | $9,456.55 | $38,794.92 | $187,260.20 |
| 2014 | $12,883.68 | $3,602.48 | $9,281.20 | $48,076.12 | $183,657.72 |
| 2015 | $12,883.68 | $3,786.78 | $9,096.90 | $57,173.02 | $179,870.94 |
| 2016 | $12,883.68 | $3,980.53 | $8,903.15 | $66,076.17 | $175,890.41 |
| 2017 | $12,883.68 | $4,184.18 | $8,699.50 | $74,775.67 | $171,706.23 |
| 2018 | $12,883.68 | $4,398.26 | $8,485.42 | $83,261.09 | $167,307.97 |
| 2019 | $12,883.68 | $4,623.27 | $8,260.41 | $91,521.50 | $162,684.70 |
| 2020 | $12,883.68 | $4,859.82 | $8,023.86 | $99,545.36 | $157,824.88 |
| 2021 | $12,883.68 | $5,108.46 | $7,775.22 | $107,320.58 | $152,716.42 |
| 2022 | $12,883.68 | $5,369.81 | $7,513.87 | $114,834.45 | $147,346.61 |
| 2023 | $12,883.68 | $5,644.53 | $7,239.15 | $122,073.60 | $141,702.08 |
| 2024 | $12,883.68 | $5,933.33 | $6,950.35 | $129,023.95 | $135,768.75 |
| 2025 | $12,883.68 | $6,236.90 | $6,646.78 | $135,670.73 | $129,531.85 |
| 2026 | $12,883.68 | $6,555.96 | $6,327.72 | $141,998.45 | $122,975.89 |
| 2027 | $12,883.68 | $6,891.40 | $5,992.28 | $147,990.73 | $116,084.49 |
| 2028 | $12,883.68 | $7,243.96 | $5,639.72 | $153,630.45 | $108,840.53 |
| 2029 | $12,883.68 | $7,614.58 | $5,269.10 | $158,899.55 | $101,225.95 |
| 2030 | $12,883.68 | $8,004.16 | $4,879.52 | $163,779.07 | $93,221.79 |
| 2031 | $12,883.68 | $8,413.67 | $4,470.01 | $168,249.08 | $84,808.12 |
| 2032 | $12,883.68 | $8,844.11 | $4,039.57 | $172,288.65 | $75,964.01 |
| 2033 | $12,883.68 | $9,296.61 | $3,587.07 | $175,875.72 | $66,667.40 |
| 2034 | $12,883.68 | $9,772.26 | $3,111.42 | $178,987.14 | $56,895.14 |
| 2035 | $12,883.68 | $10,272.21 | $2,611.47 | $181,598.61 | $46,622.93 |
| 2036 | $12,883.68 | $10,797.75 | $2,085.93 | $183,684.54 | $35,825.18 |
| 2037 | $12,883.68 | $11,350.19 | $1,533.49 | $185,218.03 | $24,474.99 |
| 2038 | $12,883.68 | $11,930.88 | $952.80 | $186,170.83 | $12,544.11 |
| 2039 | $12,886.51 | $12,544.11 | $342.40 | $186,513.23 | $0.00 |
| Totals | $386,513.23 | $200,000.00 | $186,513.23 | | |

TABLE 5
Annual Summary $200,000 at 3% 10 Years

| | Payments | Principle | Interest | | |
|---|---|---|---|---|---|
| Year | Made | Portion | Portion | Interest to Date | Principle Remaining |
| 2010 | $23,174.52 | $17,412.66 | $5,764.86 | $5,764.86 | $182,587.34 |
| 2011 | $23,174.52 | $17,942.27 | $5,232.25 | $10,997.11 | $164,645.07 |
| 2012 | $23,174.52 | $18,488.00 | $4,686.52 | $15,683.63 | $146,157.07 |
| 2013 | $23,174.52 | $19,050.34 | $4,124.18 | $19,807.81 | $127,106.73 |
| 2014 | $23,174.52 | $19,629.77 | $3,544.75 | $23,352.56 | $107,476.96 |
| 2015 | $23,174.52 | $20,226.82 | $2,947.70 | $26,300.26 | $87,250.14 |
| 2016 | $23,174.52 | $20,842.05 | $2,332.47 | $28,632.73 | $66,408.09 |
| 2017 | $23,174.52 | $21,475.97 | $1,698.55 | $30,331.28 | $44,932.12 |
| 2018 | $23,174.52 | $22,129.21 | $1,045.31 | $31,376.59 | $22,802.91 |
| 2019 | $23,174.52 | $22,802.91 | $372.24 | $31,748.83 | $0.00 |
| Totals | $231,745.20 | $200,000.00 | $31,748.83 | | |

TABLE 6
Annual Summary $200,000 at 3% 15 Years

| | Payments | Principle | Interest | | |
|---|---|---|---|---|---|
| Year | Made | Portion | Portion | Interest to Date | Principle Remaining |
| 2010 | $16,573.92 | $10,720.54 | $5,853.38 | $5,853.38 | $189,279.46 |
| 2011 | $16,573.92 | $11,046.62 | $5,527.30 | $11,380.68 | $178,232.84 |
| 2012 | $16,573.92 | $11,382.59 | $5,191.33 | $16,572.01 | $166,850.25 |
| 2013 | $16,573.92 | $11,728.80 | $4,845.12 | $21,417.13 | $155,121.45 |
| 2014 | $16,573.92 | $12,085.57 | $4,488.35 | $25,905.48 | $143,035.88 |
| 2015 | $16,573.92 | $12,453.14 | $4,120.78 | $30,026.26 | $130,582.74 |
| 2016 | $16,573.92 | $12,831.90 | $3,742.02 | $33,768.28 | $117,750.84 |
| 2017 | $16,573.92 | $13,222.21 | $3,351.71 | $37,119.99 | $104,528.63 |
| 2018 | $16,573.92 | $13,624.38 | $2,949.54 | $40,069.53 | $90,904.25 |
| 2019 | $16,573.92 | $14,038.78 | $2,535.14 | $42,604.67 | $76,865.47 |
| 2020 | $16,573.92 | $14,465.80 | $2,108.12 | $44,712.79 | $62,399.67 |
| 2021 | $16,573.92 | $14,905.76 | $1,668.16 | $46,380.95 | $47,493.91 |
| 2022 | $16,573.92 | $15,359.16 | $1,214.76 | $47,595.71 | $32,134.75 |
| 2023 | $16,573.92 | $15,826.32 | $747.60 | $48,343.31 | $16,308.43 |
| 2024 | $16,573.92 | $16,308.43 | $266.24 | $48,609.55 | $0.00 |
| Totals | $248,608.80 | $200,000.00 | $48,609.55 | | |

TABLE 7
Annual Summary $200,000 at 6% 30 Years

| | Payments | Principle | Interest | | |
|---|---|---|---|---|---|
| Year | Made | Portion | Portion | Interest to Date | Principle Remaining |
| 2010 | $14,389.20 | $2,456.01 | $11,933.19 | $11,933.19 | $197,543.99 |
| 2011 | $14,389.20 | $2,607.49 | $11,781.71 | $23,714.90 | $194,936.50 |
| 2012 | $14,389.20 | $2,768.30 | $11,620.90 | $35,335.80 | $192,168.20 |
| 2013 | $14,389.20 | $2,939.07 | $11,450.13 | $46,785.93 | $189,229.13 |
| 2014 | $14,389.20 | $3,120.33 | $11,268.87 | $58,054.80 | $186,108.80 |
| 2015 | $14,389.20 | $3,312.80 | $11,076.40 | $69,131.20 | $182,796.00 |
| 2016 | $14,389.20 | $3,517.13 | $10,872.07 | $80,003.27 | $179,278.87 |
| 2017 | $14,389.20 | $3,734.06 | $10,655.14 | $90,658.41 | $175,544.81 |
| 2018 | $14,389.20 | $3,964.35 | $10,424.85 | $101,083.26 | $171,580.46 |
| 2019 | $14,389.20 | $4,208.86 | $10,180.34 | $111,263.60 | $167,371.60 |
| 2020 | $14,389.20 | $4,468.45 | $9,920.75 | $121,184.35 | $162,903.15 |
| 2021 | $14,389.20 | $4,744.06 | $9,645.14 | $130,829.49 | $158,159.09 |
| 2022 | $14,389.20 | $5,036.67 | $9,352.53 | $140,182.02 | $153,122.42 |
| 2023 | $14,389.20 | $5,347.31 | $9,041.89 | $149,223.91 | $147,775.11 |
| 2024 | $14,389.20 | $5,677.13 | $8,712.07 | $157,935.98 | $142,097.98 |
| 2025 | $14,389.20 | $6,027.29 | $8,361.91 | $166,297.89 | $136,070.69 |
| 2026 | $14,389.20 | $6,399.04 | $7,990.16 | $174,288.05 | $129,671.65 |
| 2027 | $14,389.20 | $6,793.71 | $7,595.49 | $181,883.54 | $122,877.94 |
| 2028 | $14,389.20 | $7,212.70 | $7,176.50 | $189,060.04 | $115,665.24 |
| 2029 | $14,389.20 | $7,657.58 | $6,731.62 | $195,791.66 | $108,007.66 |
| 2030 | $14,389.20 | $8,129.90 | $6,259.30 | $202,050.96 | $99,877.76 |
| 2031 | $14,389.20 | $8,631.33 | $5,757.87 | $207,808.83 | $91,246.43 |
| 2032 | $14,389.20 | $9,163.70 | $5,225.50 | $213,034.33 | $82,082.73 |
| 2033 | $14,389.20 | $9,728.90 | $4,660.30 | $217,694.63 | $72,353.83 |
| 2034 | $14,389.20 | $10,328.94 | $4,060.26 | $221,754.89 | $62,024.89 |
| 2035 | $14,389.20 | $10,966.02 | $3,423.18 | $225,178.07 | $51,058.87 |
| 2036 | $14,389.20 | $11,642.38 | $2,746.82 | $227,924.89 | $39,416.49 |
| 2037 | $14,389.20 | $12,360.46 | $2,028.74 | $229,953.63 | $27,056.03 |
| 2038 | $14,389.20 | $13,122.81 | $1,266.39 | $231,220.02 | $13,933.22 |
| 2039 | $14,390.23 | $13,933.22 | $457.01 | $231,677.03 | $0.00 |
| Totals | $431,677.03 | $200,000.00 | $231,677.03 | | |

TABLE 8
Annual Summary $200,000 at 4% 10 Years

| | Payments | Principle | Interest | | |
|---|---|---|---|---|---|
| Year | Made | Portion | Portion | Interest to Date | Principle Remaining |
| 2010 | $24,298.80 | $16,600.94 | $7,697.86 | $7,697.86 | $183,399.06 |
| 2011 | $24,298.80 | $17,277.30 | $7,021.50 | $14,719.36 | $166,121.76 |
| 2012 | $24,298.80 | $17,981.18 | $6,317.62 | $21,036.98 | $148,140.58 |
| 2013 | $24,298.80 | $18,713.79 | $5,585.01 | $26,621.99 | $129,426.79 |
| 2014 | $24,298.80 | $19,476.22 | $4,822.58 | $31,444.57 | $109,950.57 |
| 2015 | $24,298.80 | $20,269.70 | $4,029.10 | $35,473.67 | $89,680.87 |
| 2016 | $24,298.80 | $21,095.52 | $3,203.28 | $38,676.95 | $68,585.35 |
| 2017 | $24,298.80 | $21,954.98 | $2,343.82 | $41,020.77 | $46,630.37 |
| 2018 | $24,298.80 | $22,849.47 | $1,449.33 | $42,470.10 | $23,780.90 |
| 2019 | $24,298.80 | $23,780.90 | $518.42 | $42,988.52 | $0.00 |
| Totals | $242,988.00 | $200,000.00 | $42,988.52 | | |

TABLE 9
Annual Summary $200,000 at 4% 15 Years

| | Payments | Principle | Interest | | |
|---|---|---|---|---|---|
| Year | Made | Portion | Portion | Interest to Date | Principle Remaining |
| 2010 | $17,752.56 | $9,933.34 | $7,819.22 | $7,819.22 | $190,066.66 |
| 2011 | $17,752.56 | $10,338.05 | $7,414.51 | $15,233.73 | $179,728.61 |
| 2012 | $17,752.56 | $10,759.24 | $6,993.32 | $22,227.05 | $168,969.37 |
| 2013 | $17,752.56 | $11,197.61 | $6,554.95 | $28,782.00 | $157,771.76 |
| 2014 | $17,752.56 | $11,653.79 | $6,098.77 | $34,880.77 | $146,117.97 |
| 2015 | $17,752.56 | $12,128.61 | $5,623.95 | $40,504.72 | $133,989.36 |
| 2016 | $17,752.56 | $12,622.74 | $5,129.82 | $45,634.54 | $121,366.62 |
| 2017 | $17,752.56 | $13,137.00 | $4,615.56 | $50,250.10 | $108,229.62 |
| 2018 | $17,752.56 | $13,672.20 | $4,080.36 | $54,330.46 | $94,557.42 |
| 2019 | $17,752.56 | $14,229.25 | $3,523.31 | $57,853.77 | $80,328.17 |
| 2020 | $17,752.56 | $14,808.98 | $2,943.58 | $60,797.35 | $65,519.19 |
| 2021 | $17,752.56 | $15,412.30 | $2,340.26 | $63,137.61 | $50,106.89 |
| 2022 | $17,752.56 | $16,040.23 | $1,712.33 | $64,849.94 | $34,066.66 |
| 2023 | $17,752.56 | $16,693.74 | $1,058.82 | $65,908.76 | $17,372.92 |
| 2024 | $17,752.56 | $17,372.92 | $378.69 | $66,287.45 | $0.00 |
| Totals | $266,288.40 | $200,000.00 | $66,287.45 | | |

TABLE 10
Annual Summary $200,000 at 7% 30 Years

| | Payments | Principle | Interest | | |
|---|---|---|---|---|---|
| Year | Made | Portion | Portion | Interest to Date | Principle Remaining |
| 2010 | $15,967.20 | $2,031.55 | $13,935.65 | $13,935.65 | $197,968.45 |
| 2011 | $15,967.20 | $2,178.42 | $13,788.78 | $27,724.43 | $195,790.03 |
| 2012 | $15,967.20 | $2,335.90 | $13,631.30 | $41,355.73 | $193,454.13 |
| 2013 | $15,967.20 | $2,504.77 | $13,462.43 | $54,818.16 | $190,949.36 |
| 2014 | $15,967.20 | $2,685.82 | $13,281.38 | $68,099.54 | $188,263.54 |
| 2015 | $15,967.20 | $2,880.00 | $13,087.20 | $81,186.74 | $185,383.54 |
| 2016 | $15,967.20 | $3,088.19 | $12,879.01 | $94,065.75 | $182,295.35 |
| 2017 | $15,967.20 | $3,311.43 | $12,655.77 | $106,721.52 | $178,983.92 |
| 2018 | $15,967.20 | $3,550.81 | $12,416.39 | $119,137.91 | $175,433.11 |
| 2019 | $15,967.20 | $3,807.50 | $12,159.70 | $131,297.61 | $171,625.61 |
| 2020 | $15,967.20 | $4,082.75 | $11,884.45 | $143,182.06 | $167,542.86 |
| 2021 | $15,967.20 | $4,377.88 | $11,589.32 | $154,771.38 | $163,164.98 |
| 2022 | $15,967.20 | $4,694.36 | $11,272.84 | $166,044.22 | $158,470.62 |
| 2023 | $15,967.20 | $5,033.73 | $10,933.47 | $176,977.69 | $153,436.89 |
| 2024 | $15,967.20 | $5,397.61 | $10,569.59 | $187,547.28 | $148,039.28 |
| 2025 | $15,967.20 | $5,787.81 | $10,179.39 | $197,726.67 | $142,251.47 |
| 2026 | $15,967.20 | $6,206.20 | $9,761.00 | $207,487.67 | $136,045.27 |
| 2027 | $15,967.20 | $6,654.85 | $9,312.35 | $216,800.02 | $129,390.42 |
| 2028 | $15,967.20 | $7,135.93 | $8,831.27 | $225,631.29 | $122,254.49 |
| 2029 | $15,967.20 | $7,651.79 | $8,315.41 | $233,946.70 | $114,602.70 |
| 2030 | $15,967.20 | $8,204.95 | $7,762.25 | $241,708.95 | $106,397.75 |
| 2031 | $15,967.20 | $8,798.07 | $7,169.13 | $248,878.08 | $97,599.68 |
| 2032 | $15,967.20 | $9,434.09 | $6,533.11 | $255,411.19 | $88,165.59 |
| 2033 | $15,967.20 | $10,116.07 | $5,851.13 | $261,262.32 | $78,049.52 |
| 2034 | $15,967.20 | $10,847.35 | $5,119.85 | $266,382.17 | $67,202.17 |
| 2035 | $15,967.20 | $11,631.52 | $4,335.68 | $270,717.85 | $55,570.65 |
| 2036 | $15,967.20 | $12,472.37 | $3,494.83 | $274,212.68 | $43,098.28 |
| 2037 | $15,967.20 | $13,374.00 | $2,593.20 | $276,805.88 | $29,724.28 |
| 2038 | $15,967.20 | $14,340.83 | $1,626.37 | $278,432.25 | $15,383.45 |
| 2039 | $15,973.14 | $15,383.45 | $589.69 | $279,021.94 | $0.00 |
| Totals | $479,021.94 | $200,000.00 | $279,021.94 | | |

TABLE 11
Annual Summary $200,000 at 5% 10 Years

| | Payments | Principle | Interet | | |
|---|---|---|---|---|---|
| Year | Made | Portion | Portion | Interest to Date | Principle Remaining |
| 2010 | $25,455.72 | $15,814.87 | $9,640.85 | $9,640.85 | $184,185.13 |
| 2011 | $25,455.72 | $16,623.99 | $8,831.73 | $18,472.58 | $167,561.14 |
| 2012 | $25,455.72 | $17,474.51 | $7,981.21 | $26,453.79 | $150,086.63 |
| 2013 | $25,455.72 | $18,368.55 | $7,087.17 | $33,540.96 | $131,718.08 |
| 2014 | $25,455.72 | $19,308.33 | $6,147.39 | $39,688.35 | $112,409.75 |
| 2015 | $25,455.72 | $20,296.14 | $5,159.58 | $44,847.93 | $92,113.61 |
| 2016 | $25,455.72 | $21,334.54 | $4,121.18 | $48,969.11 | $70,779.07 |
| 2017 | $25,455.72 | $22,426.08 | $3,029.64 | $51,998.75 | $48,352.99 |
| 2018 | $25,455.72 | $23,573.43 | $1,882.29 | $53,881.04 | $24,779.56 |
| 2019 | $25,455.72 | $24,779.56 | $676.24 | $54,557.28 | $0.00 |
| Totals | $254,557.20 | $200,000.00 | $54,557.28 | | |

TABLE 12
Annual Summary $200,000 at 5% 15 Years

| | Payments | Principle | Interest | | |
|---|---|---|---|---|---|
| Year | Made | Portion | Portion | Interest to Date | Principle Remaining |
| 2010 | $18,979.03 | $9,187.77 | $9,791.31 | $9,791.31 | $190,812.23 |
| 2011 | $18,979.03 | $9,657.80 | $9,321.28 | $19,112.59 | $181,154.43 |
| 2012 | $18,979.03 | $10,151.91 | $8,827.17 | $27,939.76 | $171,002.52 |
| 2013 | $18,979.03 | $10,671.30 | $8,307.78 | $36,247.54 | $160,331.22 |
| 2014 | $18,979.03 | $11,217.25 | $7,761.83 | $44,009.37 | $149,113.97 |
| 2015 | $18,979.03 | $11,791.16 | $7,187.92 | $51,197.29 | $137,322.81 |
| 2016 | $18,979.03 | $12,394.41 | $6,584.67 | $57,781.96 | $124,928.40 |
| 2017 | $18,979.03 | $13,028.54 | $5,950.54 | $63,732.50 | $111,899.86 |
| 2018 | $18,979.03 | $13,695.11 | $5,283.97 | $69,016.47 | $98,204.75 |
| 2019 | $18,979.03 | $14,395.77 | $4,583.31 | $73,599.78 | $83,808.98 |
| 2020 | $18,979.03 | $15,132.30 | $3,846.78 | $77,446.56 | $68,676.68 |
| 2021 | $18,979.03 | $15,906.47 | $3,072.61 | $80,519.17 | $52,770.21 |
| 2022 | $18,979.03 | $16,720.29 | $2,258.79 | $82,777.96 | $36,049.92 |
| 2023 | $18,979.03 | $17,575.74 | $1,403.34 | $84,181.30 | $18,474.18 |
| 2024 | $18,979.03 | $18,474.18 | $504.14 | $84,685.44 | $0.00 |
| Totals | $284,685.44 | $200,000.00 | $84,685.44 | | |

TABLE 13
Annual Summary $200,000 at 8% 30 Years

| | Payments | Principle | Interest | | |
|---|---|---|---|---|---|
| Year | Made | Portion | Portion | Interest to Date | Principle Remaining |
| 2010 | $17,610.36 | $1,670.74 | $15,939.62 | $15,939.62 | $198,329.26 |
| 2011 | $17,610.36 | $1,809.40 | $15,800.96 | $31,740.58 | $196,519.86 |
| 2012 | $17,610.36 | $1,959.59 | $15,650.77 | $47,391.35 | $194,560.27 |
| 2013 | $17,610.36 | $2,122.23 | $15,488.13 | $62,879.48 | $192,438.04 |
| 2014 | $17,610.36 | $2,298.39 | $15,311.97 | $78,191.45 | $190,139.65 |
| 2015 | $17,610.36 | $2,489.15 | $15,121.21 | $93,312.66 | $187,650.50 |
| 2016 | $17,610.36 | $2,695.75 | $14,914.61 | $108,227.27 | $184,954.75 |
| 2017 | $17,610.36 | $2,919.49 | $14,690.87 | $122,918.14 | $182,035.26 |
| 2018 | $17,610.36 | $3,161.79 | $14,448.57 | $137,366.71 | $178,873.47 |
| 2019 | $17,610.36 | $3,424.25 | $14,186.11 | $151,552.82 | $175,449.22 |
| 2020 | $17,610.36 | $3,708.43 | $13,901.93 | $165,454.75 | $171,740.79 |
| 2021 | $17,610.36 | $4,016.23 | $13,594.13 | $179,048.88 | $167,724.56 |
| 2022 | $17,610.36 | $4,349.61 | $13,260.75 | $192,309.63 | $163,374.95 |
| 2023 | $17,610.36 | $4,710.60 | $12,899.76 | $205,209.39 | $158,664.35 |
| 2024 | $17,610.36 | $5,101.58 | $12,508.78 | $217,718.17 | $153,562.77 |
| 2025 | $17,610.36 | $5,525.03 | $12,085.33 | $229,803.50 | $148,037.74 |
| 2026 | $17,610.36 | $5,983.59 | $11,626.77 | $241,430.27 | $142,054.15 |
| 2027 | $17,610.36 | $6,480.21 | $11,130.15 | $252,560.42 | $135,573.94 |
| 2028 | $17,610.36 | $7,018.06 | $10,592.30 | $263,152.72 | $128,555.88 |
| 2029 | $17,610.36 | $7,600.55 | $10,009.81 | $273,162.53 | $120,955.33 |
| 2030 | $17,610.36 | $8,231.42 | $9,378.94 | $282,541.47 | $112,723.91 |
| 2031 | $17,610.36 | $8,914.61 | $8,695.75 | $291,237.22 | $103,809.30 |
| 2032 | $17,610.36 | $9,654.51 | $7,955.85 | $299,193.07 | $94,154.79 |
| 2033 | $17,610.36 | $10,455.84 | $7,154.52 | $306,347.59 | $83,698.95 |
| 2034 | $17,610.36 | $11,323.65 | $6,286.71 | $312,634.30 | $72,375.30 |
| 2035 | $17,610.36 | $12,263.53 | $5,346.83 | $317,981.13 | $60,111.77 |
| 2036 | $17,610.36 | $13,281.40 | $4,328.96 | $322,310.09 | $46,830.37 |
| 2037 | $17,610.36 | $14,383.74 | $3,226.62 | $325,536.71 | $32,446.63 |
| 2038 | $17,610.36 | $15,577.60 | $2,032.76 | $327,569.47 | $16,869.03 |
| 2039 | $17,608.86 | $16,869.03 | $739.83 | $328,309.30 | $0.00 |
| Totals | $528,309.30 | $200,000.00 | $328,309.30 | | |

I claim:

1. A computer-based method for providing mortgage services, comprising:
storing a pool of index rates in data storage;
storing a set of credit ratings each associated with one of the index rates in data storage;
with a computer having a hardware processor, generating and displaying a user interface on a monitor prompting a user to input loan application data related to a borrower and a real estate property;
receiving the input loan application data with the computer;
running a credit rating classifier on the computer to assign one of the credit ratings based on the received loan application data; and
with a rate association module running on the computer, assigning the one of the index rates associated with the assigned one of the credit ratings to the borrower or a loan application associated with the received loan application data.

2. The method of claim 1, wherein the pool of index rates comprises a number of values and each of the values is associated with an interest rate less than about 5 percent.

3. The method of claim 2, wherein the values are each associated with an interest rate in the range of 2 to 5 percent.

4. The method of claim 2, wherein the number of values is less than about five and the credit ratings comprise a like number of ratings ranging from a highest rating to a lowest rating.

5. The method of claim 1, further comprising, with the computer, running an amortization schedule generator to generate an amortization schedule for a loan term, a loan amount, and the assigned one of the index rate.

6. The method of claim 5, wherein the generated amortization schedule is displayed on the monitor.

7. The method of claim 5, wherein the loan term is less than about 15 years.

8. The method of claim 7, wherein the loan term is 10 years or 15 years.

9. The method of claim 5, further comprising operating with the computer a mortgage documentation generator to produce one or more mortgage documents based at least in part on the amortization schedule and the assigned index rate.

10. A system for providing mortgage services, comprising:
data storage storing a pool of index rates in data storage and further storing a set of credit ratings each associated with one of the index rates in data storage;
a hardware processor receiving loan application data corresponding to a borrower and a real estate property;
a credit rating classifier run by the hardware processor operating to assign one of the credit ratings based on the received loan application data; and
a rate association module run by the hardware processor to assign the one of the index rates associated with the assigned one of the credit ratings to the borrower or a loan application associated with the received loan application data.

11. The system of claim 10, wherein the pool of index rates comprises a number of values and each of the values is associated with an interest rate less than about 5 percent.

12. The system of claim 11, wherein the values are each associated with an interest rate in the range of 2 to 5 percent.

13. The system of claim 11, wherein the number of values is less than about five and the credit ratings comprise a like number of ratings ranging from a highest rating to a lowest rating.

14. The system of claim 10, further comprising an amortization schedule generator run by the hardware processor to generate an amortization schedule for a loan term, a loan amount, and the assigned one of the index rate.

15. The system of claim 14, wherein the loan term is less than about 15 years.

16. The system of claim 15, wherein the loan term is 10 years or 15 years.

17. The system of claim 14, further comprising a mortgage documentation generator run by the hardware processor to produce at least one mortgage document based at least in part on the amortization schedule and the assigned index rate.

18. A computer-based method for providing mortgage services, comprising:
storing a pool of index rates in data storage;
storing a set of credit ratings each associated with one of the index rates in the data storage;
with a hardware processor, receiving loan application data related to a borrower and a real estate property;
running a credit rating classifier with the hardware processor to assign one of the credit ratings based on the received loan application data; and
with a rate association module running by the hardware processor, assigning the one of the index rates associated with the assigned one of the credit ratings to the borrower or a loan application associated with the received loan application data,
wherein the pool of index rates comprises a number of values and each of the values is associated with an interest rate less than about 5 percent, and
wherein the number of values is less than about five and the credit ratings comprise a like number of ratings ranging from a highest rating to a lowest rating.

19. The method of claim 18, further comprising, with the hardware processor, running an amortization schedule generator to generate an amortization schedule for a loan term, a loan amount, and the assigned one of the index rate and wherein the loan term is less than about 15 years.

20. The method of claim 18, further comprising operating, with the hardware processor, a mortgage documentation generator to produce a mortgage document based on the amortization schedule and the assigned index rate.
